(19) United States
(12) Patent Application Publication
(10) Pub. No.: US 2016/0043662 A1
(43) Pub. Date: Feb. 11, 2016

(54) Method and device for optical lighting, or heating, or cooling of the moving means, among others footwear, clothes, vehicles, vehicle parts or vehicle stickers.

(71) Applicant: Alexander Luchinskiy, Bad Kreuznach (DE)

(72) Inventor: Alexander Luchinskiy, Bad Kreuznach (DE)

(21) Appl. No.: 14/798,447

(22) Filed: Jul. 13, 2015

(30) Foreign Application Priority Data
Jul. 13, 2014 (DE) 10 2014 010 281.5
Jul. 13, 2014 (DE) 10 2014 010 282.3
Jul. 14, 2014 (DE) 10 2014 010 319.6
Jul. 15, 2014 (DE) 10 2014 010 397.8

(51) Int. Cl. H02N 2/18; H02J 7/00; B60R 13/04; A42B 1/24; A43B 3/00; A42B 1/00; F21V 33/00; A41D 27/08

(52) U.S. Cl. CPC H02N 2/181; H02N 2/186; F21V 33/0008; H02J 7/0054; A41D 27/085; A42B 1/242; A43B 3/0015; A43B 3/001; A42B 1/008; B60R 13/04

(57) ABSTRACT

Invention provides a practical application of energy converters to power moving means. To the powering belong in particular an optical lighting, heating, or cooling. To the moving means belong in particular footwear, clothes, vehicles, vehicle parts or vehicle stickers. The moving means contain details, which release an energy, in particular under the condition of mechanical loads on these details, or by deformation of these details, including among others bending, creasing, shifting, twisting, compression, tension, a combination of some of the above-mentioned kinds of deformation or other mechanical influences on these above-mentioned detail or details. Wherein either this energy is released from an internal chemical energy of the detail substance, or the energy of mechanical deformations is converted in other types of energy, in particular in an electric energy, in particular through a piezoelectric phenomenon.

### CROSS-REFERENCE TO RELATED APPLICATIONS

This application claims priority of the following previous German applications:

10 2014 010 319.6 from 14 Jul. 2014; 10 2014 010 282.3 from 13 Jul. 2014;
10 2014 010 281.5 from 13 Jul. 2014; 10 2014 010 397.8 from 15 Jul. 2014.

### STATEMENT REGARDING FEDERALLY SPONSORED RESEARCH OR DEVELOPMENT

Not Applicable

### REFERENCE TO SEQUENCE LISTING; A TABLE; OR A COMPUTER PROGRAM LISTING COMPACT DISC APPENDIX

Not Applicable

### BACKGROUND OF THE INVENTION

Portable devices for different aims are generally known, which are powered from batteries or from the outside-placed sources of electric energy.

A clothes- or shoe-lighting is also generally known, which one comprises electric lamps (light sources), wherein the a.m. lamps (light sources) are powered from batteries or from the outside-placed sources of electric energy.

A clothes- and shoe- heating or cooling is generally known, wherein the a.m. heating or cooling is powered from the batteries or from the outside-placed sources of electric energy.

A disadvantage of the a.m. devices is that a work of these devices, an execution of heating and cooling, as well as an execution of lighting is depend on the batteries or on the outside-placed sources of electric energy.

A vehicle lighting is generally known, which one comprises the electric lamps and sources of electric energy, wherein the a.m. lamps are powered from a vehicle accumulator or from a bicycle Faraday generator.

A lighting for a Road surface is also generally known, which one contains electric lamps and sources of electric energy, wherein these above mentioned lamps are powered from the outside-placed sources of electric energy.

A disadvantage of the a.m. devices is a dependence of the lighting execution from the outside-placed sources of electric energy or from massive auto-accumulator or uncomfortable for use Faraday generator.

Stickers (stripes, etc.), a.o. the not-powered by electric current or voltage stickers are generally known, which stickers optically change an outward appearance of a vehicle. The known kinds of stickers do not generate an impression of creases.

### BRIEF SUMMARY OF THE INVENTION

### AND

### DETAILED DESCRIPTION OF THE INVENTION,

### DETAILED DESCRIPTIONS OF THE EMBODIMENTS

Nevertheless there is an enough high power source of energy, which energy is generated by humen a long time during a day. This energy is wasted.

As it is known, by walking or running a muscle energy is converted in an energy of collission or friction between a foot and shoe sole, between shoe and ground, and also in an energy of bending of a shoe. And finally all these kinds of mechanic energy are converted in a heat energy. This heat energy is normally partially wasted. And other part of this energy leads to negative consequences. In winter this surplus energy leads to overheating of a foot and consequently to a perspiration of the foot. I.e. a liquid goes in a space between the foot and internal part of a footwear, which circumstance leads to a not-comfortable state, colds, and by low outer temperatures—to frost-bitten. This energy can be taken away and usefully used. This energy is high enough, which circumstance one can see by comparison of a resulting distance of walking by foot in comparison with a movement by bicycle. The result is different by the same muscle efforts. This observation gives a possibility to show obviously an amount of this wasted muscle energy.

Principles of use of this, usually wasted, energy are described below, as well as in claims 1-19.

The same principle can be used in any kinds of vehicles. Under the vehicle an any kind of means of conveyance is understood, in particular not only an automobile, but also bicycle, scooter, roller board and so on. Presently to return it back in accumulator an automobile braking energy is used. Nevertheless by vehicle moving it's separate parts (tyre cassing, fastening areas of tyre cassing to wheel rims, fastening area of a wheel to wheel axis, axle bearing, shock-absorbers and places of their fastening/hearing) are in the areas of permanent change of mehanic pressure, with a big magnitude of pressure difference. And this circumstance can cause an essential extraction of energy by a piezoelectric krystal and it's further conversion in the electric energy. By placing of mechanic-into electric piezoelectric converters in any or in several of these places, this energy of “jolting” will be converted in an electric energy, and it will be further transferred to an automobile accumulator or used directly. If there is no piezoelectric converter, this “jolting” energy is wasted useless for heat. By the way, as a consequence of energy extraction, the jolting is reduced, i.e., this extraction of energy is useful, by the way, to reduce the jolting.

In all embodiments to convert an energy of changed compression (or bending or twisting) in useful forms of energy, not only piezoelectric principle of energy conversion can be used, but also any other principles of energy conversion, including among others a conversion of the above-mentioned energy of changed compression (or bending or twisting) in chemical energy and then in light energy.

Below the some particular (but not exhoustive) detailed embodiment examples are given, which way this energy and the described above principles can be used. The described below three variants of use were elected as most typical illustrations in point, but the claimed method is not reduced to these three variants:
a) In footwear and clothes;
b) In vehicle- and transport lighting;
c) In vehicle stickers.
   a) Footwear and clothes-related examples of embodiments (s. also above):

The footwear- and clothes-related examples of embodiments of the invention are described in the following more precisely.

Footwear (including among others bicycle shoes, sport shoes, not-sport shoes, patent-leather shoes, fashionable shoes, ladies' shoes, sandals, geta, or any other kind of footwear or of foot covering) contain a detaile or details, which is (are) made of a substance, which substance radiates a light (i.e. electromagnetic waves in the visible band of electromagnetic waves spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance). Below this substance will be shortly named as “deformation lights” or “knicklights” (“glow sticks”).

In a ladies' footwear a shoe sole, a.o. a bottom part of a shoe sole, can be covered by the a.m. substance, so that the bottom (or the upper, or both) parts of the shoe sole shines, a.o. shines with red color.

As it is known, some shoes, especially ladies' shoes contain a red-coloured bottom part of shoe sole (i.e. the footwear looks red from the bottom view). In some embodiments the shoe sole can contain in it's body the a.m. “deformation lights” or “knicklights”, which are deformed by walking, and as a result they radiate a light, and besides these a.m. shoe soles are coated from bottom by a transparent or half-transparent (i.e. a.o. light-dispersed) plate (layer), and this way the bottom part of footwear lights (a.o. it lights red-coloured).

The a.m. “deformation lights” or “knicklights” also can be placed in the body of an upper part of footwear sole (be recessed in the upper part of the footwear sole), and, besides, be covered by a light-dispersing-able insole/insertion sole, so that a skin of human foot is lighted up from underside, a.o. it is lighted up coloured, a.o. red- or pink-coloured). The a.m. “deformation lights” or “knicklights” can be also placed in a foot-covering part of footwear (i.e. in the part of footwear, which one is placed above a shoe sole), s the foot can be lighted up also from above or from a side.

Instead of the a.m. “deformation lights” or “knicklights” a footwear can contain also usual sources of light, which light up a foot skin. These light sources can be powered, among other possibilities, also by a piezoelectric generator, by a fuel zell, or from an external source of electric energy.

Footwear (including among others bicycle shoes, sport shoes, not-sport shoes, ladies' shoes, or any other kind of footwear or of foot covering) can also comprise a detail (details), which contain one, several, or many diffraction gratings.

Footwear (including among others bicycle shoes, sport shoes, not-sport shoes, ladies' shoes, or any other kind of footwear or of foot covering) can also comprise a detail (details), which contain one, several, or many holograms.

Clothes (including among others bicycle or motorcycle clothes, sportswear, non-sportswear or any other kinds of the human or animal clothes or of body-covering, inclusively gloves and head cover) can contain a detail (or details), which is (are) made of a such substance, which substance radiates a light (i.e. electromagnetic waves in a visible band of the electromagnetic wave spectrum),

under the condition of mechanical loads on this substance, or by deformation of this substance (including among others bending, creasing, shifting, twisting, compression, tension, a combination of some of the above-mentioned kinds of deformation or other mechanical influences on these above-mentioned substance)

During a walking a foot generates heat. This heat comes both from foot itself and from the footwear parts because of their permanent deformations. If a foot is thermically insulated by a footwear, the foot heats up and sweats. This sweat, as a liquid, is cooled by the external cold environment, and then this liquid cools the still warm, sweating foot. To eliminate this problem, one uses normally a footwear material, which one absorbs partially the sweat and again evaporates/vaporizes it to outside.

To solve this problem, one can also do the following:

1) Instead of a heating up one can cool a foot. For example one can place in a footwear the temperature measuring devices or temperature detectors/sensors, which are obcerving the foot temperature, and then one can cool the foot (by means of any cooling device or means). Or one can heat up a foot if it is too cold. The possible energy sources, necessary for it, are given in this description.
2) One can pump out the sweat liquid by a device, which one uses an electroosmosis effect (electroendoosmosis phenomenon). Possible energy sources for this aim are given detailed in this description. (By the way, the same can be done for clothes and sleeping-bags.
3) One can pump an air through the footwear to remove the liquid and to hold the foot in an optimal temperature range. This process can, among other possibilities, take place the following way:
a) the foot heel goes up and removes the pressure from the footwear heel. The footwear heel sucks
an air from outside by means of input valves; b) the foot heel again goes down and pumps, with a whole foot together, this air forwards, through the air conduits, which air conduits are placed in a body of shue sole, wherein the a.m. input valves do not let the air out, back to outside, and wherein a.o. this air can be heatet or cooled by means of some of bier described energy sources, wherein this a.m. heat source or cooler is placed in a shoe sole; c) after that the air from the air conduits, which are placed in the a.m. shoe sole bodies, goes in a space between the foot and shoe sole/shoe walls (in the space area near the toes or in front of the toes), and then it (air) further goes inside this space up, when a step with a correspondent foot is made; d) after that the air goes to outside, wherein also holes or output valves can be made in the upper part of the footwear to make easier the air exhoust. An advantage of this method and device is, that it does not play any role more, whether the footwear walls can absorb the sweat and evaporate (vaporize) it to outside, and consequently: 1) one do not need a natural leather more; 2) transparent materials can be used in the ladies' footwear, wherein the ladies' footwear also can be weared on bare feet in cold weather or in winter; 3) a danger of chill/catarrhal diseases is essentialy reduced because of an optimal ventilation- and heat-regime and consequently elimination of sweating.
4) In winter one can use an open footwear (for example sandals) at all, wherein a direct contact of an open foot skin with the surrounding air takes place, and this way no sweat can be generated. But in this case the foot have to be heated from the botton (from a shoe sole).
5) As one variant of the embodiment the sandals can be partially covered from above (a.o. with a transparent substance), and this covering can be also heated, a.o., for example, by electric energy.

In the last two cases the shoe sole must be made of a thermoinsulated, not water-absorbing-able (may be even hydrofob) substance, and besides the form of this shoe sole have to be not pelvis-like. If snow or water find itself at a foot, or it comes in sandals, it evaporates quickly, and the foot and sandals became dry again.

In one embodiment example the open footwear, a.o. sandals, (self-evidently the both from two units of the footwear) can comprise an element, which have a high heet capacity. This element a.o. can be executed in the same form an size as a shoe sole, and a.o. it can be placed below a foot, a.o. below a shoe sole. By each walking step a mechanic energy of interaction of foot with the footwear (because of compression, bending etc.) is converted in a heat energy, and after that this energy is saved in this element in the form of heat. Simultaneously an energy release from this element into the foot and into a surrounding air takes place. This way the quick changes of temperature at the foot are prevented, and a quasistable temperature regime in the foot area is achieved. As a footwear is open, no liquid of sweat arises. Dependently on the heat capacity of the above-mentioned element and of the geometrical properties of a footwear one can prescribe or regulate a desirable temperature regime of a foot. Optionally the upper parts of a footwear (which are covering a foot from above) can also contain such elements with a high heat capacity.

6) As one possible variant, one can use a hybrid of sandals and high boots, wherein a lover part looks like the above described sandals, and an upper part looks like a part (top) of high boots.

A heating, cooling and ventilation of a footwear can be regulated also by means of a computer or of an other electronic device, or a footwear can comprise a manually-controlled or an automatical switch-on key and switch-off key, as well as a regulator of an heating system, of a cooling system or of a ventilation system of a footwear.

In one embodiment example a footwear (including among others bicycle shoes, sport shoes, not-sport shoes, patent-leather shoes, fashionable shoes, ladies' shoes, sandals, geta, or any other kind of footwear or of foot covering) is executed such way, that the a.m. footwear (shoe sole or footcovering of the a.m. footwear, which one a.o. contacts directly with a foot skeen, and therefore it can light up the foot skeen, or this footwear can light up the bottom part of the sole) contains a detail (or details), which is (are) made of a such substance,
a) which substance radiates a light (i.e. electromagnetic waves in a visible band of the electromagnetic wave spectrum), or
b) which substance radiates an infrared radiation (i.e. electromagnetic waves in an infrared band of the electromagnetic wave spectrum), or
c) which substance warms itself (produced heat energy), or
d) any kinds of combinations of the some or all three of the a.m. items (a) to (c) takes place,
   under the condition of mechanical loads on this substance, or by deformation of this substance (including among others bending, creasing, shifting, twisting, compression, tension, a combination of some of the above-mentioned kinds of deformation or other mechanical influences on these above-mentioned substance), a.o. wherein either this a.m. light is radiated from the a.m. substance directly, or firstly the the a.m. energy of mechanic deformations is converted in an electric energy (a.o. through a piezoelectric phenomenon), and then this electric energy is converted in the light energy. Below this above-described substance is called shortly as “Substance”.

As one possible partial case: If a light is radiated from this “Substance” directly, it can be a.o. so, that the mechanical compressions or bendings only release an already contained in this “Substance” chemical energy; but in this partial case no conversion of a mechanic energy into a radiation energy takes place. Such case takes place in the a.m. “knicklights”).

In one embodiment example a footwear (including among others bicycle shoes, sport shoes, not-sport shoes, patent-leather shoes, fashionable shoes, ladies' shoes, sandals, geta, or any other kind of footwear or of foot covering) is executed such way, that this footwear comprises:
a) a piezoelectric source (or piezoelectric sources) of electric current or electric voltage, and
b) sources of light (f.e. light lamps, lighting, LED-light sources, light diods, etc.), as well as also possibly (optionally):
c) an electric accumulator,
   wherein the a.m. sources of light are powered electrically from the a.m. piezoelectric sources of electric energy (directly or through an accumulator),
   wherein a.o. die a.m. sources of light are placed in a shoe sole or in any other details of a foot wear to light up a.o. either an upper part (upper surface) or a bottom part (bottom surface) of a footwear, or both upper and bottom parts, or a side part, or a fore-part of a shoe sole, or an edging of an upper part/surface of a shoe sole, or any other details of a foot wear;
   wherein a.o. the a.m. piezoelectric sources of electric energy are placed in footwear heels (a.o. in spike heels) or in a body of shoe sole.

In one embodiment example a footwear (including among others bicycle shoes, sport shoes, not-sport shoes, patent-leather shoes, fashionable shoes, ladies' shoes, sandals, geta, or any other kind of footwear or of foot covering) is executed such way, that this footwear comprises:
a) a piezoelectric source (or piezoelectric sources) of electric current or electric voltage, and
b) converter of electric energy in a heat energy or in an energy of infrared radiation, wherein the a.m. converter is electrically powered from the a.m. piezoelectric sources of electric energy;
   wherein, among other possibilities, the a.m. converter (a heating body or a source of infrared radiation) is placed in the shoe sole or in some other details of a foot wear to light up a.o. the upper parts of the shoe sole, or any other details of the foot wear, or both; wherein u.a. the a.m. piezoelectric source of electric energy is placed in a footwear heel (a.o. in a spike heel) or in a body of a shoe sole.

In one embodiment example a footwear (including among others bicycle shoes, sport shoes, not-sport shoes, patent-leather shoes, fashionable shoes, ladies' shoes, sandals, geta, or any other kind of footwear or of foot covering) is executed such way, that this footwear comprises:
a) a source of chemical energy (i.e. some chemical substance, which one can deliver chemical energy) and
b) a converter-1 of chemical energy in electric energy (fuel cell),
c) a converter-2 of electric energy in a heat- (or infrared radiation-) energy, or a converter-3 of electric energy in a light-energy (i.e. electric lighting),
   wherein the a.m. converter-1 is powered by the a.m. chemical energy source,
   wherein a.o. the a.m. converter-1 or the a.m. chemical substance or both, are placed in a shoe sole or in an other details of footwear a.o. to light up or to heat or both the upper parts of shoe sole or any other details of footwear or both,
   wherein a.o. the a.m. chemical energy source is placed in a footwear heel (a.o. in a spike heel) or in a body of shoe sole.

In one embodiment example an above-described ladies' footwear is executed, wherein the shoe sole, including among others the shoe sole upper part or the shoe sole bottom part or both, are made of (or are covered by) the above-described “Substance” (partially or completely), so that bottom (or upper, or front side elements of a footwear, or some elements of the a.m. shoe sole parts, a.o. an edge of the shoe sole upper part, or some or all of these parts and elements are shining, a.o. they shine with lights of different colors , among other possibilities the footwear can shine with a red-color from the shoe sole bottom and (or) a.o. pink-color from the shoe sole upper surface to light up a foot from the foot bottom; or (and) u.a. also any other parts of the footwear can shine.

In one embodiment example a ladies' footwear is executed, wherein the bottom part of the shoe sole, or the upper part of the shoe sole, or both are shining (a.o. the whole bottom- or upper- or both surfaces of the shoe sole are shining, a.o. they are shining with different colors, a.o. they are shining red-colored from the shoe sole bottom and (or) a.o. pink-colored from the shoe sole upper surface to light up a foot; or (and) also some other parts of foot wear are shining, for which aim the footwear comprises the correspondent sources of light and either sources of electric energy or energy converters of mechanic—into the electric energy, or energy converters of mechanic—into the optical light energy to supply the a.m. light sources with energy.

In one embodiment example a footwear (including among others bicycle shoes, sport shoes, not-sport shoes, patent-leather shoes, fashionable shoes, ladies' shoes, sandals, geta, or any other kind of footwear or of foot covering) is executed such way, that this footwear comprises a detail (or some details), which contain one, several or many diffraction grating (gratings), or the footwear is covered by small elements, wherein the dimensions of these elements, or distance between these elements, or both, are so small that they cause a diffraction of the light, which one is falling on the shoe surface, and this way the shoe surface forms a diffraction grating—similar surface structure,

or the footwear or some details of the footwear are covered by such a lacquer or by any other kind of layer coating or by such a shoe-polish/shoe-cream, which lacquer (layer coating, shoe-polish/shoe-cream, etc.) comprises small elements, wherein the dimensions of these elements, or distance between these elements, or both, are so small that they cause a diffraction of the light, which one is falling on the shoe, and this way these elements form a diffraction grating—similar surface structure on the shoe surface.

In one embodiment example a footwear (including among others bicycle shoes, sport shoes, not-sport shoes, patent-leather shoes, fashionable shoes, ladies' shoes, sandals, geta, or any other kind of footwear or of foot covering) is executed such way, that this footwear comprises a detail (or several, or many details), which detail (or details) comprise one or several or many Hologrammes.

In one embodiment example a footwear, a.o. the a.m. footwear with the diffraction grating—like elements, or the a.m. footwear with the hologrammes—like elements, or both, is executed, wherein the hologram gives an image of a humen foot (a.o. of a naked foot), wherein this image generates an impression of an open footwear.

In one embodiment example the clothes (including among others bicycle or motorcycle clothes, sportswear, non-sportswear or any other kinds of the human or animal clothes or of body-covering, inclusively gloves and head cover) are executed such way, that the clothes comprise a detail, (or details), which is (are) made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance), a.o. wherein either this a.m. light is radiated from the a.m. substance directly, or firstly the the a.m. energy of mechanic deformations is converted in an electric energy (a.o. through a piezoelectric phenomenon), and then this electric energy is converted in the light energy.

In one embodiment example the clothes (including among others bicycle or motorcycle clothes, sportswear, non-sportswear or any other kinds of the human or animal clothes or of body-covering, inclusively gloves and head cover) are executed such way, that the clothes comprise:
a) a piezoelectric source (or piezoelectric sources) of electric current or electric voltage, which source (or sources) is (are) placed either in clothes or in footwear or both, and
b) sources of light (f.e. light lamps, lighting, LED-light sources, light diods, etc.), wherein a.o. die a.m. sources of light are placed in clothes, head-dress(hat) or in any other details of clothes;
   wherein a.o. the a.m. piezoelectric sources of electric energy are placed in the clothes or in footwear heels (a.o. in spike heels) or in a body of shoe sole.

In one embodiment example an above-described footwear is executed, wherein the above-described lighting is powered by an external source of electric energy (f.e. by a battery, accumulator, etc.).

In one embodiment example a footwear (including among others bicycle shoes, sport shoes, not-sport shoes, patent-leather shoes, fashionable shoes, ladies' shoes, sandals, geta, or any other kind of footwear or of foot covering) is executed such way, that this footwear comprises:
a) a source of chemical energy (i.e. a chemical substance, which one can supply a chemical energy) and
b) a converter of chemical energy into a heat energy,
   wherein the a.m. converter is powered by the a.m. source of chemical energy,
   wherein a.o. the a.m. converter or the a.m. chemical substance, or both, are placed in a shoe sole or in any other detailes of the footwear to warm the upper parts of the shoe sole, or other detailes of the footwear, or both,
   wherein a.o. the a.m. energy source is placed in a footwear heel (a.o. in a spike heel) or in a body of a shoe sole.

In one embodiment example the sandals, a.o. wicker sandals, in particular ladies' sandals are executed such way, that the wickered (wattled) part of this footwear a.o. is either made of a transparent substance or comprises heating bodies, or both, wherein these heating bodies are powered by electric (or chemical or mechanical) energy, a.o. wherein these filament—(cord-, wire-, band-, ribbon-)—kind electric—into heat energy converter is placed in the wickered lines (cords or bands), or these wickered lines are these converters themselves, wherein also an additional heat source (a.o. according to one of the above-presented descriptions) can be placed also in the sandals sole.

In one embodiment example the sandals, a.o. wicker sandals, in particular ladies' sandals are executed such way, that the wickered (wattled) part of the footwear a.o. is made of a transparent substance wherein an above mentioned heat source (a.o. according to one of the given above descriptions) is placed in the sandals sole.

In one embodiment example the sandals, a.o. wicker sandals, in particular ladies' sandals are executed such way, that their upper part a.o. is made of a transparent substance, wherein a heat source is placed in the sandals sole.

In one embodiment example the sandals a method for optimisation of heating, cooling and ventilation of a footwear is executed, wherein the method comprises the following steps:

a) the foot heel goes up and removes the pressure from the footwear heel. The footwear heel sucks
an air from outside by means of input valves; b) the foot heel again goes down and pumps, with a whole foot together, this air forwards, through the air conduits, which air conduits are placed in a body of shue sole, wherein the a.m. input valves do not let the air out, back to outside, and wherein a.o. this air can be heatet or cooled by means of some above-described energy sources, wherein this a.m. heat source or cooler is placed in a shoe sole; c) after that the air from the air conduits, which are placed in the a.m. shoe sole bodies, goes in a space between the foot and shoe sole/shoe walls (in the space area near the toes or in front of the toes), and then it (air) further goes inside this space up, when a step with a correspondent foot is made; d) after that the air goes to outside, wherein also holes or output valves can be made in the upper part of the footwear to make easier the air exhoust.

In one embodiment example a footwear (a.o. the above-described footwear) is executed, wherein a firm brand (trade-mark, mark, sign, logo, specimen, brand name, brand image) on the footwear (or in the footwear, or near the footwear—f.e. as a hologram) is lighted up, with which aim a.o. a picture of the brand comprises a lighting, or the brand-forming lines, a.o. also prints/types, contain the light-radiating lines or other light-radiating parts.

In one embodiment example a clothes is executed, wherein a firm brand (trade-mark, mark, sign, logo, specimen, brand name, brand image) is lighted up, with which aim, a.o. a picture of the brand comprises a lighting, or the brand-forming lines, a.o. also prints/types, contain the light-radiating lines or other light-radiating parts. Or the clothes comprises hologram, which one is powered by electrical energy, or by light energy, or by other form of energy, wherein this hologram a.o. contains an above-mentioned firm brand (trade-mark, mark, sign, logo, specimen, brand name, brand image).

In one embodiment example a footwear or clothes are executed, a.o. according to one of the above-presented descriptions, wherein a firm brand (trade-mark, mark, sign, logo, specimen, brand name, brand image) or it's part or parts is (are) provided with identity protection means or security protective means (as money-banknotes or securities) against a counterfeit-production.

b) Vehicle- and transport lighting-related examples of embodiments (s. also above):

The vehicle- and transport lighting-related examples of embodiments of the invention are described in the following more precisely.

A vehicle (a.o. automobile, bicycle, motorcycle, or similar), comprises a detail (or details), which is (are) made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance)

The a.m. detail or details can be placed also at a front part of a bicycle frame, a.o. in (or in mechanical contact with, or near) a fastening space of the bicycle handlebars to a front part of bicycle frame, wherein a light-emitting surface of the substance is placed at the frame perpendicularly to the direction of bicycle motion, and this surface is front-oriented, consequently this detail play a role of a front headlight (a.o. of a main headlight or of an additional headlight).

The a.m. detail or details can be placed also at a back part of the bicycle frame, a.o. in (or in mechanical contact with, or near) a fastening place of a bicycle saddle to the back part of bicycle frame, wherein a light-emitting surface of the substance is placed at the frame perpendicularly to the direction of bicycle motion, and this surface is back-oriented, consequently this detail play a role of a back headlight (a.o. of a main backlight or of an additional backlight).

Wheel of a vehicle (or of a bicycle, or of a motorcycle or of an other kind of vehicle) comprises a detail (or details), which is (are) made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance)

An a.m. wheel can be also characterized by a circumstance, that the a.m. detail (or details) or admixtures of the a.m. substance are placed in the areas of maximal or essential gradient of mechanic stresses happening during the wheel motion (which areas are, for example,
at (in, on) the wheel chamber, or
at (in, on) the wheel tyre casing, or
at (in, on) the external surface of the wheel tyre caising, which contacts with a roadway covering, or
in the wheel tyre casing as substance admixtures (under the term “substance” a substance according to the hier above- and below-given description is meant), or
at (in, on) the wheel spokes between the different spokes, or
in (or near) the fastening area of spokes to a wheel rim of to a wheel axis, or
at (in, on) the wheel axis,
etc.)

An area of fastening of a wheel tyre casing (or of a wheel chamber) to the wheel, among other possibilities at the wheel rim (or an area of contact of wheel tyre casing to the wheel) comprises a detail (or details), which is (are) made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance)

The material (substance) of a wheel tyre casing can be made of a such substance, or the material (substance) of a wheel tyre casing can contain some details or admixtures, which are made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance).

Vehicle (a.o. bicycle or motorcycle or any other vehicle) can contain:

a) a piezoelectric source (or piezoelectric sources) of electric current or electric voltage, and
b) sources of light (f.e. light lamps, lighting, LED-light sources, light diods, etc.), as well as also possibly (optionally) c) an electric accumulator,
wherein the a.m. sources of light are powered electrically from the a.m. piezoelectric sources of electric energy (directly or through an accumulator), and wherein the a.m. piezoelectric source (or piezoelectric sources) is (are) placed in the areas of maximal or essential mechanic stresses or gradients of mechanic stresses (as for example in resiliency area or wheel suspension area, a,o. in spiral spring-, sheet-, torsion-bar-, or other kinds of suspension resiliency area, in the resiliency area of a (a.o. bicycle-, motorcycle-, or vehicle-) frame, or in a fastening area of bicycle- or motorcycle- saddle to a bicycle- or motorcycle- frame, or in a fastening area of a wheel to a wheel axis, or in a fastening area of a tyre cassing (or wheel chamber) to a wheel rim etc.).

An antenna of a vehicle, or a rod of a vehicle (or of a bicycle, or of a motorcycle, or of any other vehicle) for warning marking of a child bicycle or of a child bicycle chair or of a child bicycle trailer or of a trailer of a vehicle can be made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance), or this a.m. rod contains a detail (or details), which is (are) made of the above-mentioned substance.

Electric bicycle (or electric car, or vehicle, a.o. vehicle with electric propulsion) can contain a piezoelectric source (or piezoelectric sources) of an electric current or of electric voltage (i.e. piezoelectric generator or piezoelectric generators), which generator(s) convert vibrations of the a.m. vehicle or bicycle or their details in the electric energy, or which generator(s) convert an energy of any other mechanic loads on the a.m. details or of deformations of these details (including among others bending, creasing, shifting, twisting, compression, tension, a combination of some of the above-mentioned kinds of deformation or other mechanical influences on them) into the electric energy, and after that this electric energy is either used directly in this a.m. bicycle or vehicle, or it is firstly saved in an electric accumulator, wherein the a.m. piezoelectric generators are placed in the areas of maximal or essential mechanic stresses or gradients of mechanic stresses (as for example in resiliency area or wheel suspension area, a,o. in spiral spring-, sheet-, torsion-bar-, or other kinds of suspension resiliency area, in the resiliency area of a (a.o. bicycle-, motorcycle-, or vehicle-) frame, or in a fastening area of bicycle- or motorcycle- saddle to a bicycle- or motorcycle- frame, or in a fastening area of a wheel to a wheel axis, or in a fastening area of a tyre cassing (or wheel chamber) to a wheel rim etc.).

Roadway covering (pavement) can also contain some details, which are made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance).

A roadway covering (pavement) (for example autobahn covering, highway covering, or also railway embankment can also contain:
a) a piezoelectric source (or piezoelectric sources) of electric current (voltage) and
b) sources of light (for example light lamps, lighting, etc.), which light sources are placed in a body of the roadway covering (f.e. in the autobahn covering, in the highway covering, or in the railway embankment), wherein, besides, these light sources are forming a lighting road making-out (as for example the lines (a.o. continuous lines, discontinuous lines, the lines, which are marking the road limits or lanes), arrows, crosswalk marking, etc.), wherein the a.m. light sources are powered by the a.m. piezoelectric sources of electric energy.

A roadway covering (pavement) (for example autobahn covering, highway covering, or also railway embankment) can also contain: a) a piezoelectric source (or piezoelectric sources) of electric current (voltage) and b) sources of light (for example light lamps, lighting, LED-light sources, light diods, etc.), wherein the a.m. light sources are electrically powered by the a.m. piezoelectric sources of electric energy, and wherein the a.m. sources of light are placed along the a.m. roadway covering to light up the a.m. roadway covering. Among other possibilities, the a.m. light sources can be placed at the external side of the roadway covering, a.o. below, directly nearby the roadway covering external boundary to light up the roadway covering from the side. Or, among other possibilities, the a.m. light sources can be placed in usual places on a wire above a street central line, or on a street lamppost, to light up the roadway covering.

In one embodiment example a roadway covering (pavement) (for example autobahn covering, highway covering, or also railway embankment) is executed, wherein this roadway covering comprises some details, which are made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance), a.o. wherein either this a.m. light is radiated from the a.m. substance directly, or firstly the the a.m. energy of mechanic deformations is converted in an electric energy (a.o. through a piezoelectric phenomenon), and then this electric energy is converted in the light energy.

In one embodiment example a roadway covering (pavement) (for example autobahn covering, highway covering, or also railway embankment) is executed, wherein this roadway covering comprises a) a piezoelectric source (or piezoelectric sources) of electric current (voltage) and b) sources of light (for example light lamps, lighting, etc.), which light sources are placed in a body of the roadway covering (f.e. in the autobahn covering, in the highway covering, or in the railway embankment). This way these light sources are forming a lighting road making-out (as for example the lines (a.o. continuous lines, discontinuous lines, the lines, which are marking the road limits or lanes), arrows, crosswalk marking, etc.), wherein the a.m. light sources are powered by the a.m. piezoelectric sources of electric energy.

In one embodiment example a roadway covering (pavement) (for example autobahn covering, highway covering, or also railway embankment) is executed, wherein this roadway covering comprises: a) a piezoelectric source (or piezoelectric sources) of electric current (voltage) and b) sources of light (for example light lamps, lighting, LED-light sources, light diods, etc.), wherein the a.m. light sources are electrically powered by the a.m. piezoelectric sources of electric energy, and wherein the a.m. sources of light are placed along the a.m. roadway covering to light up the a.m. roadway covering, wherein a.o., the above-mentioned light sources are placed at the external side of the roadway covering, a.o. below, directly nearby the roadway covering external boundary to light up the roadway covering from the side. Or, among other possibilities, the a.m. light sources are placed in usual places on a wire above a street central line, or on a street lamppost, to light up the roadway covering.

In one embodiment example a vehicle (a.o. an automobile, a bicycle, a motorcycle or any other vehicle) is executed, wherein this vehicle (bicycle, motorcycle, etc.) comprises a detail (or details), which is (are) made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance), a.o. wherein either this a.m. light is radiated from the a.m. substance directly, or firstly the the a.m. energy of mechanic deformations is converted in an electric energy (a.o. through a piezoelectric phenomenon), and then this electric energy is converted in the light energy.

In one embodiment example a vehicle (bicycle, motorcycle, etc.) according to the above-presented description is executed, wherein the detail or the a.m. details is (are) placed at a front part of a bicycle frame, a.o. in (or in mechanical contact with, or near) a fastening space of the bicycle handlebars to a front part of bicycle frame, wherein a light-emitting surface of the substance is placed at the frame perpendicularly to the direction of bicycle motion, and this surface is front-oriented, consequently this detail play a role of a front headlight (a.o. of a main headlight or of an additional headlight).

In one embodiment example a vehicle (bicycle, motorcycle, etc.) is executed, wherein the detail or the details is (are) placed at a back part of the bicycle frame, a.o. in (or in mechanical contact with, or near) a fastening place of a bicycle saddle to the back part of bicycle frame, wherein a light-emitting surface of the substance is placed at the frame perpendicularly to the direction of bicycle motion, and this surface is back-oriented, consequently this detail play a role of a back headlight (a.o. of a main backlight or of an additional backlight).

In one embodiment example a wheel of a bicycle (or of a motorcycle or of a vehicle) is executed, wherein the wheel comprises a detail (or details), which is (are) made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance), a.o. wherein either this a.m. light is radiated from the a.m. substance directly, or firstly the the a.m. energy of mechanic deformations is converted in an electric energy (a.o. through a piezoelectric phenomenon), and then this electric energy is converted in the light energy.

In one embodiment example a wheel is executed, wherein a detail (details) or admixtures of the a.m. substance are placed in the areas of maximal or essential gradient of mechanic stresses happening during the wheel motion (which areas are, for example, at (in, on) the wheel chamber, or at (in, on) the wheel tyre casing, or at (in, on) the external surface of the wheel tyre caising, which contacts with a roadway covering, or in the wheel tyre casing as admixtures of the substance), or at (in, on) the wheel spokes between the different spokes, or in (or near) the fastening area of spokes to a wheel rim of to a wheel axis, or at (in, on) the wheel axis, etc.)

In one embodiment example a wheel is executed, wherein the a.m. detail (the a.m. details), or the made of the a.m. substance admixtures, are placed at (on, in) the wheel spokes.

In one embodiment example a wheel is executed, wherein the a.m. detail (the a.m. details), or the made of the a.m. substance admixtures, are placed at (on, in) the areas of mechanic contact of a wheel rim with a wheel tyre casing (or with a wheel chamber, or both).

In one embodiment example a wheel of a bicycle (or of a motorcycle or of any vehicle) is executed, wherein an area of fastening of a wheel tyre casing (or of a wheel chamber) to the wheel, among other possible places to the wheel rim (or place of contact of the rim to the wheel) comprises a detail (or details), which is (are) made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance), a.o. wherein either this a.m. light is radiated from the a.m. substance directly, or firstly the the a.m. energy of mechanic deformations is converted in an electric energy (a.o. through a piezoelectric phenomenon), and then this electric energy is converted in the light energy.

In one embodiment example a wheel tyre casing of a bicycle, or of a motorcycle, or of a vehicle) is executed, wherein the material of a wheel tyre casing is made of a substance, or the material of a wheel tyre casing contains some details or admixtures, which are made of a such substance,

which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance),

In one embodiment example a vehicle (automobile, bicycle, motorcycle or any other vehicle) is executed, wherein this vehicle (automobile, bicycle, motorcycle, etc.) contains: a) a piezoelectric source (or piezoelectric sources) of electric current or electric voltage, and b) sources of light (f.e. light lamps, lighting, LED-light sources, light diods, etc.), as well as also possibly (optionally) c) an electric accumulator, wherein the a.m. sources of light are powered electrically from the a.m. piezoelectric sources of electric energy (directly or through an accumulator), and wherein the a.m. piezoelectric source (or piezoelectric sources) is (are) placed in the areas of maximal or essential mechanic stresses or gradients of mechanic stresses (as for example in resiliency area or wheel suspension area, a,o. in spiral spring-, sheet-, torsion-bar-, or other kinds of suspension resiliency area, in the resiliency area of a (a.o. bicycle-, motorcycle-, or vehicle-) frame, or in a fastening area of bicycle- or motorcycle- saddle to a bicycle- or motorcycle- frame, or in a fastening area of a wheel to a wheel axis, or in a fastening area of a tyre cassing (or wheel chamber) to a wheel rim etc.).

In one embodiment example an antenna of a vehicle, or a rod (bar) of a vehicle (or of a bicycle, or of a motorcycle, or of any other vehicle) for warning marking of a child bicycle or of a child bicycle chair or of a child bicycle trailer or of a trailer of a vehicle can be made of a such substance, which substance radiates a light (i.e. electromagnetic waves in a visible band of the electromagnetic wave spectrum), under the condition of mechanical loads on this substance, or by deformation of this substance (including among others bending, creasing, shifting, twisting, compression, tension, a combination of some of the above-mentioned kinds of deformation or other mechanical influences on these above-mentioned substance), a.o. wherein either this a.m. light is radiated from the a.m. substance directly, or firstly the the a.m. energy of mechanic deformations is converted in an electric energy (a.o. through a piezoelectric phenomenon), and then this electric energy is converted in the light energy.

In one embodiment example an electric bicycle (or electric car, or vehicle, a.o. vehicle with electric propulsion) is executed, wherein this a.m. bicycle (or vehicle) contains a piezoelectric source (or piezoelectric sources) of an electric current or of electric voltage (i.e. piezoelectric generator or piezoelectric generators), which generator(s) convert vibrations of the a.m. bicycle or vehicle or their details in the electric energy, or which generator(s) convert an energy of any other mechanic loads on the a.m. details or of deformations of these details (including among others bending, creasing, shifting, twisting, compression, tension, a combination of some of the above-mentioned kinds of deformation or other mechanical influences on them) into the electric energy, and after that this electric energy is either used directly in this a.m. bicycle or vehicle, or it is firstly saved in an electric accumulator, wherein the a.m. piezoelectric generators are placed in the areas of maximal or essential mechanic stresses or gradients of mechanic stresses (as for example in resiliency area or wheel suspension area, a,o. in spiral spring-, sheet-, torsion-bar-, or other kinds of suspension resiliency area, in the resiliency area of a (a.o. bicycle-, motorcycle-, or vehicle-) frame, or in a fastening area of bicycle- or motorcycle- saddle to a bicycle- or motorcycle- frame, or in a fastening area of a wheel to a wheel axis, or in a fastening area of a tyre cassing (or wheel chamber) to a wheel rim etc.).

c) Vehicle stickers- related examples of embodiments (s. also above):

The vehicle stickers- related examples of embodiments of the invention are described in the following more precisely.

Not-even car body surfaces, which can contain all kinds of breaks in surface curve cross-section, are fashionable. The case in point are not only breaks, but also other kinds of not-monotonies of the car body surface cross-section lines, among other possibilities all kinds of bends (curvatures), flections, windings, zigzags, etc. In further description below all not-monotonies of the car body are named as car body breaks or as breaks.

The existing problems of the car body outward appearance:

1) Old car models do not have these breaks, and therewith they looks not fashionable and consequently less prestigious (this problem exists mainly in countries of the former USSR and in analogous lands).
2) One cannot change a general car body outward appearance (for example dependently on the esthetic preferences of a car owner, or dependently on a current fashion for some definite time period or for some definite country, etc.). This outward appearance is given for all life time of the car body.
3) The fashion- or aesthetic-caused forms of breaks are not obligatory correspond to the aerodynamically optimal forms of breaks.

The above-mentioned problems can be solved such way, that instead of the car body breaks such stickers (a.o. shade stripes) are used on a car body, which make an optical image of a break, although factually exists. With another words, this sticker reflects a light exactly the same way, or similar way, as a real break on the car body.

This aim is attained such way, that the sticker contains on the one hand both optically light-coloured and dark parts, and on the other hand a linear boundary (boundary) between these parts, wherein these parts are putting in order one in respect to another the same way, as the zones of a really breaked car body surface.

As an other solution, a sticker can contain only one (either an optically light-coloured or an optically dark-coloured part. But this optically light coloured (or dark) part have to be in optical contrast with the lightness or darkness of the main colour of the car body surface, as it is described above. And this way an impression of shade is generated.

In one embodiment example a sticker to put on a car body surface is executed, which sticker, on it's optical features, is optically contrasting with the colour of the car body, wherein the sticker consists of at least two optically different parts (or stripes) with sharply designated (indicated, defined, characterised) optical boundary, wherein one of these parts is light coloured (a.o. it is permanently lighted up), and the second part is dark (or wherein one of these parts is more dark, then the other one, and the second part is more light then the other one), and the boundary line between these parts is considerably optically designated because of the different brightness of these parts, wherein all stripes are so placed on a car body, that the boundaries between the stripes, or the boundaries between the a.m. parts are parallel to the visible on a car body lines, or these boundaries are copying the forms of these car body lines, a.o. these boundaries are also horisontal or almost horisontal.

In one embodiment example a sticker is executed, wherein the sticker consists of at least two, optically (on their optical features) different parts, which parts have different light reflection characteristical features, wherein one of these parts is bright, and the second one of these parts is dark (or wherein one of these parts is more dark, then the other one, and the second part is more light then the other one), and the boundary line between these parts is considerably optically designated because of the different brightness of these parts,

In one embodiment example a method for producing of a car body with the optically recognizable

from outside breaks of the car body surface is executed, wherein the breaks have an esthetic, but not an aerodynamic or any other useful funktion, wherein the car body is produced first without these breaks, and after that the flat stripes (or paints combination immediate on a car body) with the optical image of these a.m. breaks are put on the car body.

In all above-described embodiment examples the more light part of a sticker (among other possible variants) can be permanently lighted up, a.o. by the electric energy, which on is produced according to the above-described way.

The stickers can also contain a) elements of geometrical optics (as for example lenses of any kinds of forms, or prisms of any kind of forms) or/and b) elements of physical (wave)-optics (as for example Fresnel-lenses or Fresnel-mirrors), as well as the elements for generation of holografic images, which a.m. elements can also, a.o. be powered by the above-described method of energy generation.

(Abbreviation “a.m.” (from the German “o.g.”) means “above-mentioned”; Abbreviation “a.o.” (from the German “u.a.”) means “including among others” or “among other possibilities”).

What is claimed is:

1. Footwear (including among others bicycle shoes, sport shoes, not-sport shoes, patent-leather shoes, fashionable shoes, ladies' shoes, sandals, geta, or any other kind of footwear or of foot covering) or clothes (including among others bicycle or motorcycle clothes, sportswear, non-sportswear or any other kinds of the human or animal clothes or of body-covering, inclusively gloves and head cover),
wherein
the footwear or the clothes contain a detaile (mean) or details (means), which release an energy a.o. under the condition of mechanical loads on this detaile (on these detailes), or by deformation of this detaile/ these detailes (including among others bending, creasing, shifting, twisting, compression, tension, a combination of some of the above-mentioned kinds of deformation or other mechanical influences on these above-mentioned detaile or detailes), wherein either the a.m. energy is released from an internal chemical energy of the detaile substance, or the a.m. energy of mechanical deformations is converted in other types of energy, among other possibilities in an electric energy, among other possibilities through a piezoelectric phenomenon, or, among other possibilities, the footwear or clothes is supplied, additionally or exclusively, by an energy from an external source of electric energy (for example from a battery, accumulator, etc.).

2. Footwear on claim 1,
wherein this footwear comprises, among others, the following elements:
an energy converter, among other possibilities a piezoelectric converter of mechanic energy into electric energy, for the convertion of mechanical energy of interaction of feet with footwear into electric energy, wherein this piezoelectric energy converter can contain the following elements:
a) one, several or many piezoelectric plate or plates, which plate or plates convert a pressure energy of a human foot (among other possibilities of a human heel, of a whole foot sole-area or of an anatomic kontact area of a foot sole with a shoe sole) into electric energy, wherein the compression phase and the opposite tension phase are generated periodically by each step during a walking or running, and wherein this piezoelectric plate (plates) can be placed in a footwear heel, or in (or on, or below, etc.) a body of a whole shoe sole, or in the places of anatomic kontact areas of foot with a shoe sole, or in any other place of a footwear; or
b) one, several or many piezoelectric plate or plates, which plate or plates convert a bending energy of a human foot into electric energy, wherein the bending phase and the opposite unbending phase are generated periodically by each step during a walking or running, and wherein this piezoelectric plate (plates) can be placed in (or on, or below, etc.) a body of a whole shoe sole, or in the places of anatomic kontact areas of bending foot joints with a shoe sole (among others in the footwear toe under the foot toe joints), or in any other place of a footwear; or
c) one, several or many piezoelectric plate or plates, which plate or plates can execute some of the above mentioned kinds of deformation (including among others bending, creasing, shifting, twisting, compression, tension) in a footwear, and this way to convert a mechanic energy in an electric energy;
a battery (accumulator), which one is suitable for use in portable devices (as for example mobile telephones or all kind of smartphones, or tablet—computers and so on), or a battery (accumulator), which one is suitable for charging of the above-mentioned portable devices (as for example mobile telephones or all kind of smartphones, or tablet—computers and so on);
a device (means) for fastening of this battery (as for example groove/slot, pocket, connector, etc.), which one is placed, among other possibilities, on (in) a footwear;
an electric connection to connect and disconnect electrically the a.m. battery in the a.m. fastening with the a.m. piezoelectric converter, and an electric conduction from the a.m. converter to the a.m. battery;
an adapter (optionally, when needed), which one gives a possibility to connect the different kinds of the a.m. batteries with the a.m. piezoelectric converter, and besides to fasten the different kinds of the a.m. batteries at a footwear, wherein the batteries can be fasten also outside the footwear (for example at a shin).

3. Footwear on claim 1, wherein the a.m. footwear, including a.o. a sole or a foot cover of the a.m. footwear, which one a.o. contacts directly with a foot skeen, and therefore it can light up the foot skeen, or this footwear can light up the bottom part of the sole, wherein this footwear contains a detail (or details), which is (are) made of a such substance,
a) which substance radiates a light (i.e. electromagnetic waves in a visible band of the electromagnetic wave spectrum), or
b) which substance radiates an infrared radiation (i.e. electromagnetic waves in an infrared band of the electromagnetic wave spectrum), or
c) which substance warms itself (produced heat energy), or
d) which substance combines some or all three of the listed above properties,
under the condition of mechanical loads on this substance, or by deformation of this substance (including among others bending, creasing, shifting, twisting, compression, tension, a combination of some of the above-mentioned kinds of deformation or other mechanical influences on these above-mentioned substance), a.o. wherein either this a.m. light is radiated from the a.m. substance directly, or firstly the the a.m. energy of mechanic deformations is converted in an electric energy (a.o. through a piezoelectric phenomenon), and then this electric energy is converted in the light energy.

4. Footwear on claim 1, wherein the footwear comprises:
a) a piezoelectric source (or piezoelectric sources) of electric current or electric voltage, and
b) sources of light (f.e. light lamps, lighting, LED-light sources, light diods, etc.), as well as also possibly (optionally) c) an electric accumulator,
wherein the a.m. sources of light are powered electrically from the a.m. piezoelectric sources of electric energy (directly or through an accumulator),
wherein a.o. the a.m. sources of light are placed in a shoe sole or in any other details of a foot wear to light up a.o. either an upper part (upper surface) or a bottom part (bottom surface) of a footwear, or both upper and bottom parts, or a side part, or a fore-part of a shoe sole, or an edging of an upper part/surface of a shoe sole, or any other details of a foot wear;
wherein a.o. the a.m. piezoelectric sources of electric energy are placed in footwear heels (a.o. in spike heels) or in a body of shoe sole.

5. Footwear on claim 1, wherein the footwear comprises:
a) a piezoelectric source (or piezoelectric sources) of electric current or electric voltage, and
b) converter of electric energy in a heat energy or in an energy of infrared radiation, wherein, among other possibilities, the a.m. converter (a heating body or a source of infrared radiation) is placed in the shoe sole or in some other details of a foot wear to light up a.o. the upper parts of the shoe sole, or any other details of the foot wear, or both;
wherein u.a. the am. piezoelectric source of electric energy is placed in a footwear heel (a.o. in a spike heel) or in a body of a shoe sole.

6. Footwear on claim 1, wherein the footwear comprises:
a) a source of chemical energy (i.e. some chemical substance, which one can supply a chemical energy), and
b) a converter-1 of the chemical energy in an electric energy (fuel cell),
c) a converter-2 of the electric energy in a heat—(or infrared radiation-) energy or a converter-3 of the electric energy in the light—energy (i.e. electrical lighting),
wherein the am. converter-1 is powered by the a.m. chemical energy source,
wherein a.o. the a.m. converter-1 or the a.m. chemical substance or both, are placed in a shoe sole or in an other details of footwear a.o. to light up or to heat or both the upper parts of shoe sole or any other details of footwear or both,
wherein a.o. the a.m. chemical energy source is placed in a footwear heel (a.o. in a spike heel) or in a body of shoe sole.

7. Footwear on claim 3,
including among others the ladies' footwear, wherein the shoe sole, including among others the shoe sole upper part or the shoe sole bottom part or both, are made of (or are covered by) the substance on claim 3 (partially or completely), so that bottom (or upper, or front side elements of a footwear, or some elements of the a.m. shoe sole parts, a.o. an edge of the shoe sole upper part, or some or all of these parts and elements are shining, a.o. they shine with lights of different colors , among other possibilities the footwear can shine with a red-color from the shoe sole bottom and (or) a.o. pink-color from the shoe sole upper surface to light up a foot from the foot bottom; or (and) u.a. also any other parts of the footwear can shine.

8. Footwear on claim 3,
including among others the ladies' footwear, wherein the bottom part of the shoe sole, or the upper part of the shoe sole, or both are shining (a.o. the whole bottom- or upper- or both surfaces of the shoe sole are shining, a.o. they are shining with different colors, a.o. they are shining red-colored from the shoe sole bottom and (or) a.o. pink-colored from the shoe sole upper surface to light up a foot; or (and) also some other parts of foot wear are shining, for which aim the footwear comprises the correspondent sources of light and either sources of electric energy or energy converters of mechanic—into the electric energy, or energy converters of mechanic—into the optical light energy to supply the a.m. light sources with energy.

9. Footwear on claim 1, wherein
the footwear comprises a detail (details), which comprise one, several or many diffraction grating (gratings),
or the footwear is covered by small elements, wherein the dimensions of these elements, or distance between these elements, or both, are so small that they cause a diffraction of the light, which one is falling on the shoe surface, and this way the shoe surface forms a diffraction grating—similar surface structure,
or the footwear or some details of the footwear are covered by such a lacquer or by any other kind of layer coating or by such a shoe-polish/shoe-cream, which lacquer (layer coating, shoe-polish/shoe-cream, etc.) comprises small elements, wherein the dimensions of these elements, or distance between these elements, or both, are so small that they cause a diffraction of the light, which one is falling on the shoe, and this way these elements form a diffraction grating—similar surface structure on the shoe surface.

10. Footwear on claim 1, wherein
the footwear comprises a detail (or several, or many details), which one comprises one or several or many Hologrammes.

11. Footwear on claim 1, wherein
the footwear is executed in an open form (a.o. as sandals), wherein the footwear comprises element(s), which have a high heet capacity, wherein by each walking step a mechanic energy of interaction of foot with the footwear (because of compression, bending etc.-s. claim 1) is converted in a heat energy, and after that this energy is saved in this element in the form of heat, and simultaneously an energy release from this element into the foot and into a surrounding air takes place, which way these two processes result a thermical equilibrium, and this way the quick changes of temperature at the foot are prevented, and a quasistable temperature regime in the foot area is achieved.

12. Clothes on claim 1, wherein
the clothes contain a detail (or details), which is (are) made of a such substance, which substance radiates a light (i.e. electromagnetic waves in a visible band of the electromagnetic wave spectrum),
under the condition of mechanical loads on this substance, or by deformation of this substance (including among others bending, creasing, shifting, twisting, compression, tension, a combination of some of the above-mentioned kinds of deformation or other mechanical influences on these above-mentioned substance), a.o. wherein either this am. light is radiated from the a.m. substance directly, or firstly the the a.m. energy of mechanic deformations is converted in an electric energy (a.o. through a piezoelectric phenomenon), and then this electric energy is converted in the light energy.

13. Clothes on claim 1, wherein the clothes comprise:
a) a piezoelectric source (or piezoelectric sources) of electric current or electric voltage, which source (or sources) is (are) placed either in clothes or in footwear or both, and
b) sources of light (f.e. light lamps, lighting, LED-light sources, light diods, etc.),
wherein a.o. die a.m. sources of light are placed in clothes, head-dress(hat) or in any other details of clothes;
wherein a.o. the a.m. piezoelectric sources of electric energy are placed in the clothes or in footwear heels (a.o. in spike heels) or in a body of shoe sole.

14. Footwear on claim 1, wherein the footwear comprises:
a) a source of chemical energy (i.e. a chemical substance, which one can supply a chemical energy) and
b) a converter of chemical energy into a heat energy,
wherein the a.m. converter is powered by the am. source of chemical energy,
wherein a.o. the a.m. converter or the a.m. chemical substance, or both, are placed in a shoe sole or in any other detailes of the footwear to warm the upper parts of the shoe sole, or other detailes of the footwear, or both,
wherein a.o. the a.m. energy source is placed in a footwear heel (a.o. in a spike heel) or in a body of a shoe sole.

15. Footwear on claim 1,
including among others sandals, a.o. wicker sandals, in particular ladies' sandals, wherein the wickered (wattled) part of the footwear a.o. is either made of a transparent substance or comprises heating bodies, or both, wherein these heating bodies are powered by electric (or chemical or mechanical) energy, a.o. wherein these filament—(cord-, wire-, band-, ribbon-)—kind electric—into heat energy converter is placed in the wickered lines (cords or bands), or these wickered lines are these converters themselves, wherein also the above mentioned additional heat sources can be placed also in the sandals sole.

16. Footwear on claim 1,
including among others sandals, a.o. wicker sandals, in particular ladies' sandals, wherein the wickered (wattled) part of the footwear a.o. is made of a transparent substance wherein an above mentioned heat source is placed in the sandals sole.

17. Footwear on claim 1,
including among others sandals, a.o. wicker sandals, in particular ladies' sandals, wherein an upper part of a footwear a.o. is made of a transparent substance, wherein a heat source is placed in the sandals sole.

18. Method for optimisation of heating, cooling and ventilation of a footwear, wherein the method comprises the following steps:
a) the foot heel goes up and removes the pressure from the footwear heel. The footwear heel sucks
an air from outside by means of input valves; b) the foot heel again goes down and pumps, with a whole foot together, this air forwards, through the air conduits, which air conduits are placed in a body of shue sole, wherein the a.m. input valves do not let the air out, back to outside, and wherein a.o. this air can be heatet or cooled by means of some energy sources, wherein this a.m. heat source or cooler is placed in a shoe sole; c) after that the air from the air conduits, which are placed in the a.m. shoe sole bodies, goes in a space between the foot and shoe sole/shoe walls (in the space area near the toes or in front of the toes), and then it (air) further goes inside this space up, when a step with a correspondent foot is made; d) after that the air goes to outside, wherein also holes or output valves can be made in the upper part of the footwear to make easier the air exhoust.

19. Footwear or clothes on claim 1, wherein
the contained in a footwear or in clothes firm brand (trade-mark, mark, sign, logo, specimen, brand name, brand image) is lighted up, with which aim a picture of the brand comprises a lighting, or the brand-forming lines, a.o. also prints/types, contain the light-radiating lines or other light-radiating parts.

20. Footwear or clothes on claim 1, wherein a firm brand (trade-mark, mark, sign, logo, specimen, brand name, brand image) or it's part or parts is (are) provided with identity protection means or security protective means (as money-banknotes or securities) against a counterfeit-production.

21. Vehicle (a.o. automobile, bicycle, motorcycle, vehicle with electric propulsion, electric car, electric bicycle), wherein
this a.m. vehicle (or bicycle) comprises a piezoelectric source (or piezoelectric sources) of an electric current or of electric voltage (i.e. piezoelectric generator or piezoelectric generators), which generator(s) convert vibrations of the a.m. vehicle or bicycle or their details in the electric energy, or which generator(s) convert an energy of any other mechanic loads on the a.m. details or of deformations of these details (including among others bending, creasing, shifting, twisting, compression, tension, a combination of some of the above-mentioned kinds of deformation or other mechanical influences on them) into the electric energy, and after that this electric energy is either used directly in this a.m. bicycle or vehicle, or it is firstly saved in an electric accumulator, wherein the a.m. piezoelectric generators are placed in the areas of maximal or essential mechanic stresses or gradients of mechanic stresses (as for example in resiliency area or wheel suspension area, a,o. in spiral spring-, sheet-, torsion-bar-, or other kinds of suspension resiliency area, in the resiliency area of a (a.o. bicycle-, motorcycle-, or vehicle-) frame, or in a fastening area of bicycle- or motorcycle-saddle to a bicycle- or motorcycle-frame, or in a fastening area of a wheel to a wheel axis, or in a fastening area of a tyre cassing (or wheel chamber) to a wheel rim etc.).
